(19) United States
(12) Patent Application Publication
(10) Pub. No.: US 2011/0085955 A1
(43) Pub. Date: Apr. 14, 2011

(54) SYSTEM AND METHOD FOR REDUCING NO2 POISONING

(75) Inventor: Mikael LARSSON, Molndal (SE)

(73) Assignee: ALSTOM TECHNOLOGY LTD, Baden (CH)

(21) Appl. No.: 12/577,316

(22) Filed: Oct. 12, 2009

(51) Int. Cl. C01B 31/20; B01J 8/02

(52) U.S. Cl. 423/230; 422/211

(57) ABSTRACT

A CO₂ capture system 200 including a system for removing NO₂ from a first gas stream 210 before CO₂ capture is disclosed. The CO₂ capture system 200 includes a protection bed 220 and a CO₂ absorber 260. The protection bed 220 may absorb the NO₂ or convert the NO₂ to either NO or N₂.

### FIELD

The present disclosure generally relates to a power generation plant, and more particularly relates to systems and methods for protecting carbon dioxide (CO₂) absorber from nitrogen dioxide (NO₂) poisoning by removing harmful contaminants from a CO₂ rich stream.

### BACKGROUND

Carbon dioxide is a useful chemical for enhanced oil recovery by means of injecting it into an oil reservoir where it tends to dissolve into the oil in place, thereby reducing its viscosity and thus making it more mobile for movement toward the producing well. Other commercial uses CO₂ are as carbonation in beverages, a mild acidification chemical and as a cooling agent in the form of a liquid or a solid (i.e. “dry ice”).

Emissions of CO₂ into the atmosphere are thought to be harmful due to its “greenhouse gas” property contributing to global warming. The major source of anthropogenic CO₂ is the combustion of fossil fuels. The largest sources of CO₂ emissions are coal combustion for electricity generation, the use of coke for steelmaking and the use of petroleum products as a transportation and heating fuel. Other sources are natural gas fired electrical generating stations, industrial boilers for generating steam and for co-generating steam and electricity, the tail gas from fluidized catalytic cracking unit regenerators and the combustion of petroleum coke as a fuel. Gas streams emitted from such facilities may contain a significant amount of CO₂, which could be recovered and used in other industrial processes.

By way of example, flue gas from a fossil fuel power generation station such as a coal fired thermal generating station or steam boiler is a plentiful source of CO₂ suitable for capture, often containing about 12 volume percent (vol. %) CO₂. The flue gas usually also contains residual oxygen, nitrogen and sulfur oxides and particulate matter (“fly ash”). NO is produced during the combustion process by reaction of the nitrogen content of the fuel with oxygen and also by the oxidation of the nitrogen of the of the combustion air at the high combustion temperature. The NO may then be partially oxidized to NO₂ by the residual O₂ in the flue gas. The extent of this reaction is usually quite small, so that the NO/NO₂ ratio in most of the waste gas streams discussed previously herein is quite large, and particularly so in flue gas. Most coal derived flue cases also contain sulfur oxides, principally SO₂, with a much lesser amount of SO₃. The SO₃ will react with water vapor present in the flue gas to form sulfuric acid (H₂SO₄) at temperatures below about 339° C. and will then condense into fine droplets (“acid mist”) as the flue gas cools. Further, other acidic contaminants, such as hydrogen chloride and hydrofluoric acid, may also be present in some flue gas streams. Solid contaminants, such as fluid catalytic cracking (FCC) catalysts fines, unburned carbon or metal oxides are also often present in some flue gases. The emission of all of these minor contaminants is generally regulated in order to preserve air quality and prevent acid rain and smog. For example, a process for the capture of CO₂ can aid in controlling the regulated pollutants. As such, processes have been developed and are in use to capture CO₂ and/or to purify gas streams to the levels regulated by government.

Many processes have developed for the capture of CO₂ from gas streams, including polymer and inorganic membrane permeation, scrubbing with a solvent that is chemically reactive with CO₂ and/or physical solvent, and the use of monoethanolamine solvent absorption/stripping type of regenerative process. Another attractive process is physical absorption using dry regenerable absorbents. However, these absorbents often suffer from poisoning by contaminants present in gas streams such as flue gas streams.

What is needed is a method and system for removing poisoning contaminants from a contaminated gas stream before providing the gas stream for CO₂ capture.

### SUMMARY

According to aspects illustrated herein, there is provided a CO₂ capture system including a protection bed 220 configured to receive a first gas stream 210 and to substantially remove NO₂ from the first gas stream to produce a second gas stream 230, and a CO₂ capture unit 260 configured to produce a CO₂ rich stream 280 from the second gas stream 230.

According to other aspects illustrated herein, there is provided a facility including a component generating a first gas stream 210, and a CO₂ capture system 200 for removing CO₂ from the first gas stream 210. The CO₂ capture system 200 includes a protection bed 220 configured to receive the first gas stream 210 and to substantially remove NO₂ from the first gas stream 210 to produce a second gas stream 230, and a CO₂ capture unit 260 configured to produce a CO₂ rich gas stream from the second gas stream 230.

According to other aspects illustrated herein, a method for removing carbon dioxide from a gas stream 210 includes providing a first gas stream to a protection bed 220, the protection bed 220 configured to substantially remove NO₂ from the gas stream 210 to produce a second gas stream 230, and providing the second gas stream to a CO₂ capture unit 260 to produce a CO₂ rich gas stream 280.

The above described and other features are exemplified by the following figures and detailed description.

### BRIEF DESCRIPTION OF THE DRAWINGS

Referring now to the figures, which are exemplary embodiments, and wherein the like elements are numbered alike.

FIG. 1 is a graph showing the effect of exposure time on CO₂ absorption capacity.

FIG. 2 is a schematic of an exemplary embodiment of a CO₂ capture system according to the disclosure.

FIG. 3 is a schematic of an exemplary embodiment of a regeneration system according to the disclosure.

FIG. 4 is a schematic of another exemplary embodiment of a CO₂ capture system according to the disclosure.

FIG. 5 is a schematic of yet another exemplary embodiment of a CO₂ capture system according to the disclosure.

### DETAILED DESCRIPTION

A method and system for treating a gas stream for CO₂ capture is provided. The method and system provide for a NOₓ storage and reduction catalyst and the continuous reduction of NO₂ by a reducing agent. The system for CO₂ capture may be integrated into a fossil fuel power generation station to treat the power generation flue gas.

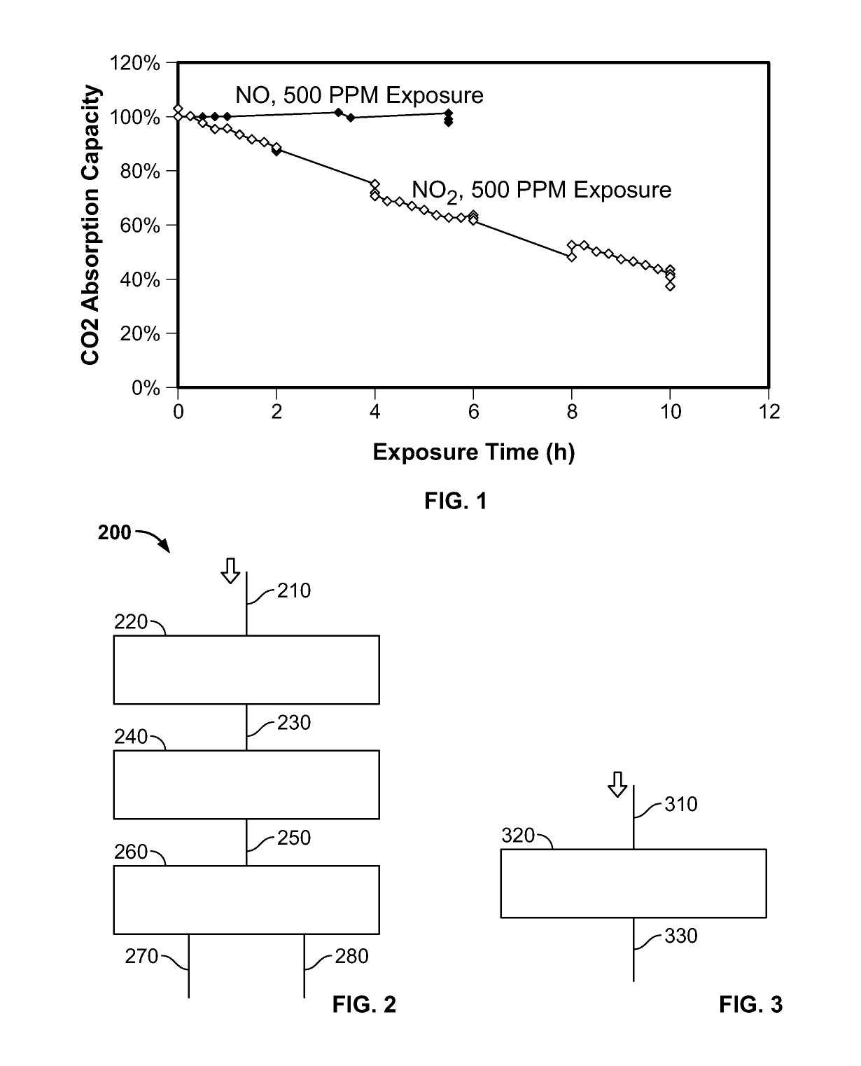

FIG. 1 shows the adverse affect that NO₂ has upon the ability of an amine-containing dry CO₂ absorber material. As can be seen in FIG. 1, an exposure time of approximately 10 hours to a gas stream containing 500 ppm NO₂ reduces the CO₂ absorption capacity by about 60%. It should be noted that the exposure to NO had little or no effect upon the ability of the absorbent to absorb CO₂.

FIG. 2 shows a first exemplary embodiment of a CO₂ capture system 200 according to the disclosure. As can be seen in FIG. 2, a first gas stream 210 is provided to a protection bed 220. In one embodiment, the first gas stream 210 is a gas stream containing CO₂. The first gas stream 210 is generated by a gas stream generating component. In one embodiment, the gas stream containing CO₂ may be a flue gas stream generated from a power generation unit. For example, the power generation unit may be a fossil fuel power generation unit, such as, but not limited to, a coal fired power generation unit. In another embodiment, the gas stream containing CO₂ may be generated from a component of a manufacturing facility such as, but not limited to, an aluminum or steel production facility. The first gas stream 210 includes, but is not limited to, CO₂ and NO₂. In one embodiment, the first gas stream 210 is a flue gas stream containing CO₂, NO, NO₂ and other contaminants.

The protection bed 220 includes a NOₓ storage and reduction catalyst. The NOₓ storage and reduction catalyst includes a storage material and a reduction catalyst. The storage material may be a Group I oxide, a Group II oxide or other material capable of storing the formed gas component. The reduction catalyst may be a precious metal or other material capable of promoting or catalyzing the reduction reaction. For example, the NOₓ storage and reduction catalyst may be a barium and/or potassium oxide and a precious metal. In one embodiment, the precious metal may be Pt, Pd, Rh and/or combinations thereof. For example, in one embodiment, the storage and reduction catalyst is a barium or potassium oxide and platinum that absorbs NO₂ but does not absorb NO between about 80° C. and about 150° C. In one embodiment, the storage and reduction catalyst is maintained at about 100° C. during operation.

At the protection bed 220, the first gas stream is brought into contact with the storage and reduction catalyst. While the first gas stream 210 is flowing through the protection bed, NO₂ is stored in the storage and reduction catalyst. A second gas stream 230 is discharged from the protection bed 220. The second gas stream 230 contains NO and is substantially free of NO₂. In one embodiment, the second gas stream 230 contains less than 1 part per million (ppm) NO₂. In another embodiment, the second gas stream 230 contains less than 0.1 ppm NO₂. In yet another embodiment, the second gas stream 230 contains less than 0.01 ppm NO₂.

The second gas stream 230 is provided to an optional gas treatment unit 240. The gas treatment unit 240 may include a heat exchanger or other air pollution control (APC) equipment, as necessary, to prepare the second gas stream 230 for CO₂ absorption. A third gas stream 250 is discharged from the gas treatment unit 240 and provided to a CO₂ capture unit 260. In one embodiment, the CO₂ capture unit 260 includes a CO₂ absorber. In another embodiment, the CO₂ capture unit 260 includes a dry CO₂ absorber. In yet another embodiment, the CO₂ capture unit 260 includes an advanced amine system.

In another embodiment, the gas treatment unit 240 is not provided and the second gas stream 230 is provided to the CO₂ capture unit 260. In another embodiment, the gas treatment unit 240 may be placed before the protection bed 220, so as to treat the gas stream 210 before it is provided to the protection bed 220.

A fourth gas stream 270 is discharged from the CO₂ capture unit 260 for further processing. In one embodiment, the fourth gas stream 270 is provided to a discharge stack (not shown). The fourth gas stream 270 is a CO₂ reduced gas stream. In one embodiment, the fourth gas stream 270 contains about 50 to about 95 volume percent (vol %) of the CO₂ contained in the first gas stream 210. For example, the fourth gas stream 270 may contain about 0.5 to about 5.0 vol % CO₂. The remainder of the fourth gas stream 270 contains mostly N₂ and water vapor.

Additionally, a CO₂ rich gas stream 280 is discharged from the dry CO₂ absorber for further processing. In one embodiment, the CO₂ rich gas stream 280 is further purified and then compressed. In one embodiment, the CO₂ rich gas stream 280 includes more than about 50 vol % CO2. In another embodiment, the CO2 rich gas stream 280 includes between about 50 and about 99 vol % CO₂. In yet another embodiment, the CO₂ rich gas stream 280 includes more than 98 vol % CO₂. In another embodiment, the CO₂ rich gas stream 280 includes more than 99 vol % CO₂.

FIG. 3 shows an exemplary embodiment for regenerating the protection bed 220. As discussed above, while the first gas stream 210 (FIG. 1) is flowing through the protection bed 210, NO₂ is stored by the storage and reduction catalyst. After a period of time, it is necessary to remove the stored NO₂ from protection bed 220, and this is performed by regenerating the protection bed 220. As can be seen in FIG. 3, a reduction gas stream 310 is provided to the protection bed 220 to regenerate the protection bed 220. The reduction gas stream 310 contains a reducing agent. In one embodiment, the reducing agent may be, but is not limited to, hydrogen, carbon monoxide, a hydrocarbon, ammonia and combinations thereof. The reduction gas stream 310 may further include nitrogen, steam and oxygen. In one embodiment, the protection bed 220 is maintained at a temperature between about 150° C. to about 500° C. during regeneration. In another embodiment, the protection bed 220 is maintained at a temperature between about 250° C. and about 300° C. during regeneration. In yet another embodiment, the protection bed is maintained at a temperature of about 300° C. during regeneration. In one embodiment, the reduction gas stream 310 contains steam and hydrogen gas. The reduction gas stream 310 may be provided in the same or different stream piping to the protection bed 220 as the first gas stream 210 (FIG. 2).

In the protection bed 220, the reducing agent reacts with the absorbed NO₂ to form nitrogen (N₂) and water (H₂O). In such a manner, the NOₓ storage and reduction catalyst in the protection bed 220 is regenerated. The N₂ and H₂O are discharged from the protection bed via a regenerative discharge gas stream 330. The regenerative discharge gas stream 330 may be discharged from the protection bed 220 via the same or different stream piping as the second gas stream 230 (FIG. 2). In one embodiment, the regenerative discharge gas stream 330 is recirculated back into the first gas stream 210 (FIG. 2).

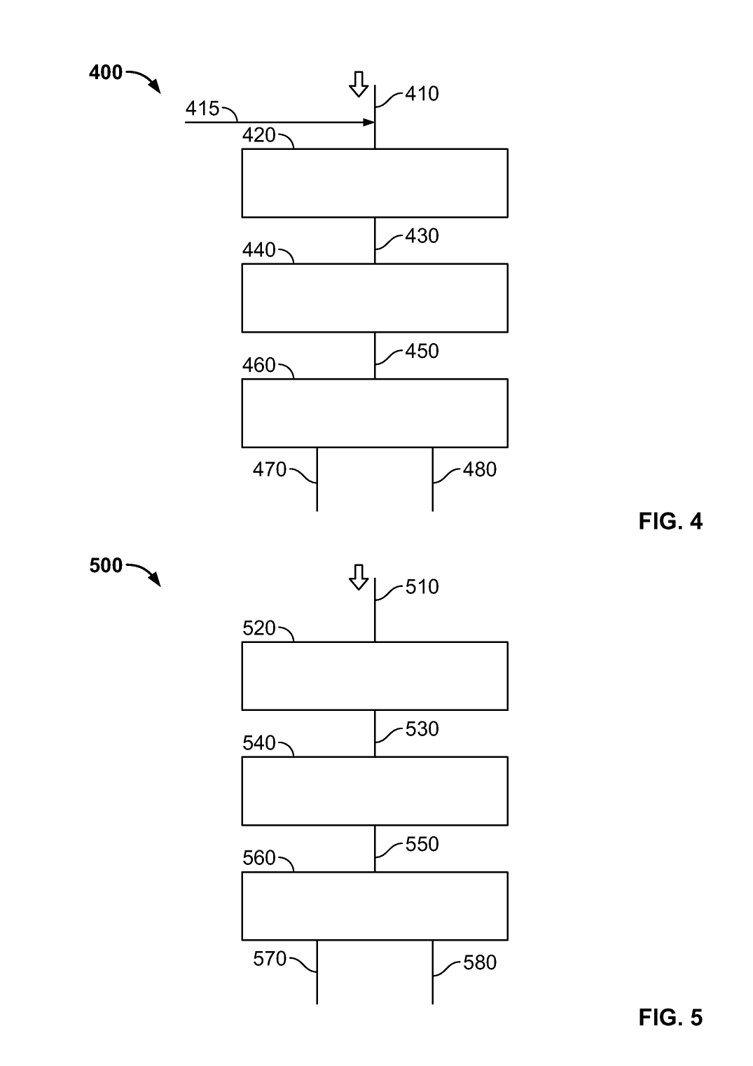

FIG. 4 shows another exemplary embodiment of a CO₂ capture system 400 according to the disclosure. In this embodiment, the treatment process is a continuous process not requiring catalyst regeneration. As can be seen in FIG. 4, a first gas stream 410 is provided to a protection bed 420. In one embodiment, the first gas stream 410 is a flue gas stream containing CO₂, NO, NO₂ and other contaminants. The protection bed 420 includes a catalyst capable of converting NO₂ to NO in the presence of a reducing agent at a predetermined temperature range. In one embodiment, the catalyst may be an oxidation catalyst capable of converting NO₂ to NO. In another embodiment, the catalyst may be cobalt, a precious metal, or a metal oxide catalyst. In one embodiment, the metal oxide catalyst may be a barium oxide, potassium oxide, cerium oxide, aluminum oxide, titanium oxide or vanadium oxide. In one embodiment the precious metal catalyst may be a Pt, Pd or Ag catalyst. In a preferred embodiment, the precious metal catalyst is platinum.

The catalyst facilitates the conversion of NO₂ to NO within a specific temperature range. For example, in one embodiment, a precious metal catalyst facilitates the conversion of NO₂ to NO between about 100° C. and about 200° C. In one embodiment, the catalyst is maintained at about 100° C.

A reducing agent stream 415 introduces a reducing agent into the first gas stream 410. The reducing agent may be selected from the group including, but not limited to, as hydrogen, carbon monoxide, hydrocarbon, and ammonia. In one embodiment, the reducing agent is an unsaturated hydrocarbon. For example, the reducing agent may be propene. In another example, the reducing agent is carbon monoxide, which reacts with NO₂ in the presence of the catalyst to form CO₂ and NO as shown by Equation 1.

NO₂+CO→NO+CO₂ (Equation 1)

In another example, the reducing agent is ammonia, which reacts with the NO₂ in the presence of the catalyst to form N2 and NO as shown in Equation 2

3NO₂+2NH₃→N₂+3H₂O (Equation 2)

A second gas stream 430 is discharged from the protection bed 420. The second gas stream contains the reaction products from the NO₂ reduction reaction. The second gas stream 430 contains NO and is substantially free of NO₂. In one embodiment, the second gas stream 430 contains less than 1 part per million (ppm) NO₂. In another embodiment, the second gas stream 430 contains less than 0.1 ppm NO₂. In yet another embodiment, the second gas stream 430 contains less than 0.01 ppm NO₂.

The second gas stream 430 is provided to an optional gas treatment unit 440. The gas treatment unit 440 may include a heat exchanger or other air pollution control (APC) equipment, as necessary, to prepare the second gas stream 430 for CO₂ absorption. A third gas stream 450 is discharged from the gas treatment unit 440 and provided to a CO₂ capture unit 460. In one embodiment, the CO₂ capture unit 460 includes a CO₂ absorber. In another embodiment, the CO₂ capture unit 460 includes a dry CO₂ absorber. In yet another embodiment, the CO₂ capture unit 460 includes an advanced amine system.

In another embodiment, the gas treatment unit 440 is not provided and the second gas stream 430 is provided to the CO₂ capture unit 460. In another embodiment, the gas treatment unit 440 may be placed before the protection bed 420, so as to treat the gas stream 410 before it is provided to the protection bed 420. In another embodiment, the gas treatment unit 440 is not provided and the second gas stream 430 is provided to the CO₂ capture system 460.

A fourth gas stream 470 is discharged from the dry CO₂ absorber 460 for further processing. In one embodiment, the fourth gas stream 470 is provided to a discharge stack (not shown). The fourth gas stream 470 is a CO₂ reduced gas stream. In one embodiment, the fourth gas stream 470 contains about 50 to about 95 volume percent (vol %) of the CO₂ contained in the first gas stream 410. For example, the fourth gas stream 470 may contain about 0.5 to about 5.0 vol % CO₂. The remainder of the fourth gas stream 470 contains mostly N₂ and water vapor.

Additionally, a CO₂ rich gas stream 480 is discharged from the CO₂ capture system 460 for further processing. In one embodiment, the CO₂ rich gas stream 480 is further purified and then compressed. In one embodiment, the CO₂ rich gas stream 480 includes more than about 50 vol % CO₂. In another embodiment, the CO₂ rich gas stream 480 includes between about 50 and about 99 vol % CO₂. In yet another embodiment, the CO₂ rich gas stream 480 includes more than 98 vol % CO₂. In another embodiment, the CO₂ rich gas stream 480 includes more than 99 vol % CO₂.

FIG. 5 shows another exemplary embodiment of a CO₂ capture system 500 according to the disclosure. In this embodiment, the treatment process is a continuous process process. As can be seen in FIG. 5, a first gas stream 510 is provided to a protection bed 520. In one embodiment, the first gas stream 510 is a flue gas stream containing CO₂, NO, NO₂ and other contaminants. The protection bed 520 includes a carbon source material. In one embodiment, the carbon source material absorbs NO₂. In this example, the carbon source material may be, but is not limited to, activated carbon. In one embodiment, the carbon source material absorbs NO₂ at temperatures between about 150° C. and about 250° C. When the carbon source material becomes spent and is ineffective in absorbing NO₂, the spent carbon source material is destroyed or otherwise removed from the protection bed 520 and replaced with new and/or additional carbon source material. In one embodiment, the spent carbon source material is discharged from the protection bed 520. In another embodiment, the spent carbon source material is combusted or otherwise removed from the protection bed 520 and replaced with new and/or additional carbon source material.

In another embodiment, the carbon source material is brought into contact with the first gas stream 510 at a low temperature so that the carbon source material reacts with the NO₂ to form CO or CO₂ and NO. In one embodiment, the carbon source material is a carbonaceous fuel. For example, the carbon source material may be coal. In one embodiment, the carbonaceous fuel reacts with the NO₂ at temperatures between about 150° C. and about 250° C. to form CO and/or CO₂ and NO. The protection bed 520 may be a bed or similar reaction vessel for contacting the first gas stream 510 with the carbonaceous fuel.

A second gas stream 530 is discharged from the protection bed 520. The second gas stream 530 contains NO and is substantially free of NO₂. In one embodiment, the second gas stream 530 contains less than 1 part per million (ppm) NO₂. In another embodiment, the second gas stream 530 contains less than 0.1 ppm NO₂. In yet another embodiment, the second gas stream 530 contains less than 0.01 ppm NO₂.

The second gas stream 530 is provided to an optional gas treatment unit 540. The gas treatment unit 540 may include a heat exchanger or other air pollution control (APC) equipment, as necessary, to prepare the second gas stream 530 for CO₂ absorption. A third gas stream 550 is discharged from the gas treatment unit 540 and provided to a CO₂ capture unit 560. In one embodiment, the CO₂ capture unit 560 includes a CO₂ absorber. In another embodiment, the CO₂ capture unit 560 includes a dry CO₂ absorber. In yet another embodiment, the CO₂ capture unit 560 includes an advanced amine system.

In another embodiment, the gas treatment unit 540 is not provided and the second gas stream 530 is provided to the CO₂ capture unit 560. In another embodiment, the gas treatment unit 540 may be placed before the protection bed 520, so as to treat the first gas stream 510 before it is provided to the protection bed 520.

A fourth gas stream 570 is discharged from the CO₂ capture system 560 for further processing. In one embodiment, the fourth gas stream 570 is provided to a discharge stack (not shown). The fourth gas stream 570 is a CO₂ reduced gas stream. In one embodiment, the fourth gas stream 570 contains about 50 to about 95 vol % of the CO₂ contained in the first gas stream 510. For example, the fourth gas stream 570 may contain about 0.5 to about 5.0 vol % CO₂. The remainder of the fourth gas stream 570 contains mostly N₂ and water vapor.

Additionally, a CO₂ rich gas stream 580 is discharged from the CO₂ capture system 560 for further processing. In one embodiment, the CO₂ rich gas stream 580 is further purified and then compressed. In one embodiment, the CO₂ rich gas stream 580 includes more than about 50 vol % CO₂. In another embodiment, the CO₂ rich gas stream 580 includes between about 50 and about 99 vol % CO₂. In yet another embodiment, the CO₂ rich gas stream 580 includes more than 98 vol % CO₂. In another embodiment, the CO₂ rich gas stream 580 includes more than 99 vol % CO₂.

One advantage of the present disclosure is the effective removal of NO₂ from gas streams.

Another advantage of the present disclosure is the effective removal of NO2 from a flue gas stream in preparation for CO₂ absorption.

Another advantage of the present invention is the removal of NO2 from a gas stream by a continuous process.

Yet another advantage of the present disclosure is the effective removal of NO2 from a flue gas steam in preparation for CO₂ pressurization.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A CO₂ capture system, comprising:
a protection bed 220 configured to receive a first gas stream 210 and to substantially remove NO₂ from the first gas stream to produce a second gas stream 230; and
a CO₂ capture unit 260 configured to produce a CO₂ rich stream 280 from the second gas stream 230.

2. The system of claim 1, further comprising:
a gas treatment unit 240 configured to remove contaminants from the first gas stream 210 or the second gas stream 230.

3. The system of claim 1, wherein the protection bed 220 comprises a reduction catalyst to convert NO₂ in the first gas stream 210 to NO.

4. The system of claim 1, wherein the protection bed 220 comprises a catalyst and a reducing agent to reduce NO₂ in the first gas stream 210 to NO.

5. The system of claim 1, wherein the protection bed 220 comprises a carbon source material.

6. The system of claim 3, wherein the reducing agent is selected from the group comprising an unsaturated hydrocarbon, carbon monoxide and ammonia.

7. A facility, comprising:
a component generating a first gas stream 210 comprising CO₂; and
a CO₂ capture system 200 for removing CO₂ from the first gas stream 210, the CO₂ capture unit 200 comprising:
a protection bed 220 configured to receive the first gas stream 210 and to substantially remove NO₂ from the first gas stream 210 to produce a second gas stream 230; and
a CO₂ capture unit 260 configured to produce a CO₂ rich gas stream from the second gas stream 230.

8. The facility of claim 7, further comprising:
a gas treatment unit 240 configured to remove contaminants from the first gas stream 210 or the second gas stream 230.

9. The facility of claim 7, wherein the protection bed 220 comprises a reduction catalyst to convert NO₂ in the first gas stream 210 to NO.

10. The facility of claim 7, wherein the protection bed 220 comprises a catalyst and a reducing agent to reduce NO₂ in the first gas stream 210 to NO.

11. The facility of claim 7, wherein the protection bed 220 comprises a carbon source material.

12. The facility of claim 10, wherein the reducing agent is selected from the group comprising an unsaturated hydrocarbon, carbon monoxide and ammonia.

13. A method for removing carbon dioxide from a gas stream 210, comprising:
providing a first gas stream to a protection bed 220, the protection bed 220 configured to substantially remove NO₂ from the gas stream 210 to produce a second gas stream 230;
providing the second gas stream to a CO₂ capture unit 260 to produce a CO₂ rich gas stream 280.

14. The method of claim 13, further comprising:
removing contaminants from the first gas stream 210 or the second gas stream by a gas treatment unit 240.

15. The method of claim 13, wherein the protection bed 220 comprises a reduction catalyst to convert NO₂ in the first gas stream 210 to NO.

16. The method of claim 13, wherein the protection bed 220 comprises a catalyst and a reducing agent to reduce NO₂ in the first gas stream 210 to NO.

17. The method of claim 13, wherein a reducing agent is provided to the gas stream 210.

18. The method of claim 13, wherein the method is continuous.

19. The method of claim 13, wherein the NO₂ is removed from the gas stream 210 by reacting or absorbing the NO₂ with a carbon source material.

20. The method of 13, further comprising:
regenerating the protection bed 220 by flowing a reduction gas stream through the protection bed 220.
